(19) United States
(12) Patent Application Publication
(10) Pub. No.: US 2025/0269545 A1
(43) Pub. Date: Aug. 28, 2025

(54) MACHINE

(71) Applicant: FANUC CORPORATION, Yamanashi (JP)

(72) Inventor: Hidetoshi Uematsu, Yamanashi (JP)

(21) Appl. No.: 19/194,501

(22) Filed: Apr. 30, 2025

Related U.S. Application Data
(63) Continuation of application No. PCT/JP2023/004350, filed on Feb. 9, 2023.

(51) Int. Cl. B25J 18/00

(52) U.S. Cl. CPC B25J 18/00

(57) ABSTRACT

A machine including a first actuator and a second actuator; a first linear body that couples an external power source to the first actuator; a first wiring part that is provided to the first linear body; and a second linear body that couples the second actuator to the first wiring part.

### CROSS-REFERENCE TO RELATED APPLICATIONS

This application is a bypass continuation application of International Application No. PCT/JP2023/004350 filed Feb. 9, 2023.

### BACKGROUND

### Field

The present disclosure relates to a machine.

### Discussion of the Related Art

In recent years, machines such as robots and machine tools, comprise a plurality of actuators. Each of the plurality of actuators includes a motor, an amplifier, etc. The plurality of actuators or the amplifiers of the plurality of actuators are connected to each other by a bus connection or a daisy-chain connection. As a result, current from an external power source can be supplied to each of the plurality of actuators (refer to, for example, Japanese Unexamined Patent Publication (Kokai) No. 2015-093329).

However, in the case of a daisy-chain connection, both an input terminal and an output terminal are necessary for each actuator. As a result, the board area of the actuator becomes larger, whereby the actuator becomes larger. Thus, the machine comprising the plurality of actuators becomes larger as well.

In the case of a bus connection, only one terminal is necessary for each actuator. However, when connecting to a bus, soldering operations or branching processing using a branch connector is necessary. Thus, the reliability of the machine comprising the plurality of actuators is reduced, and space is required to perform branching. Therefore, there is a problem in that the machine becomes larger.

Therefore, there is demand for a space-saving machine consisting of a plurality of actuators comprising only one terminal.

### SUMMARY

According to a first aspect of the present disclosure, there is provided a machine, comprising a first actuator and a second actuator, a first filamentary body for connecting an external power source and the first actuator, a first wiring part provided in the first filamentary body, and a second filamentary body for connecting the second actuator and the first wiring part.

The object, features, and advantages of the present disclosure will become more apparent from the description of embodiments below in association with the attached drawings.

### BRIEF DESCRIPTION OF DRAWINGS

FIG. 1 is a perspective view showing a typical machine of the present disclosure.

FIG. 2A is a block diagram of a machine based on a first embodiment.

FIG. 2B is a block diagram of a machine based on a first modification example of the first embodiment.

FIG. 2C is a block diagram of a machine based on a second modification example of the first embodiment.

FIG. 2D is a block diagram of a machine based on a third modification example of the first embodiment.

FIG. 3 is a block diagram of a machine based on a modification example of a second embodiment.

FIG. 4A is a view similar to FIG. 2B.

FIG. 4B is a view similar to FIG. 3.

FIG. 5 is a view similar to FIG. 1.

FIG. 6A is a block diagram of a machine according to the prior art.

FIG. 6B is a block diagram of another machine according to the prior art

### DETAILED DESCRIPTION OF THE EMBODIMENTS

The embodiments of the present disclosure will be described below, with reference to the attached drawings. In the drawings, corresponding constituent elements have been assigned common reference signs.

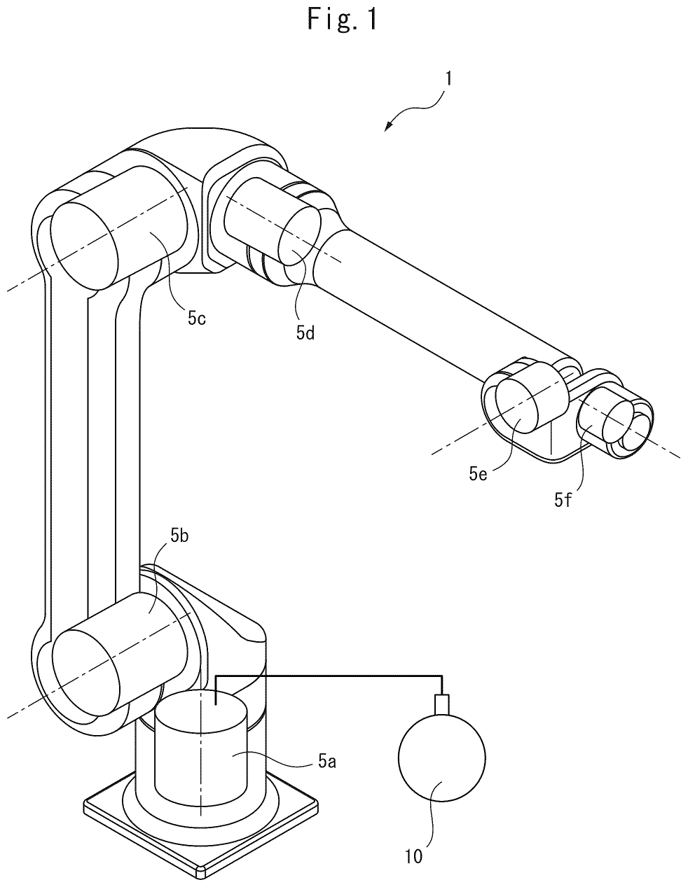

FIG. 1 is a perspective view showing a typical machine of the present disclosure. The machine 1 shown in FIG. 1 is a robot 1, for example, a six-axis vertical articulated robot. The robot 1 comprises a plurality of actuators, for example, six actuators 5a to 5f. As is well known, the actuators 5a to 5f are arranged at the respective joint axes of the robot 1. These actuators 5a to 5f are arranged in order from the base of the robot 1 toward the tip of the robot 1. An external power source 10 shown in FIG. 1 supplies electric current to the plurality of actuators 5a to 5f of the machine 1, thereby driving the machine 1.

In the following description, the machine 1 is assumed to be a robot. However, the machine 1 need only have two or more actuators, and need not necessarily have six actuators. The machine 1 may also be another machine comprising a plurality of actuators, such as a machine tool.

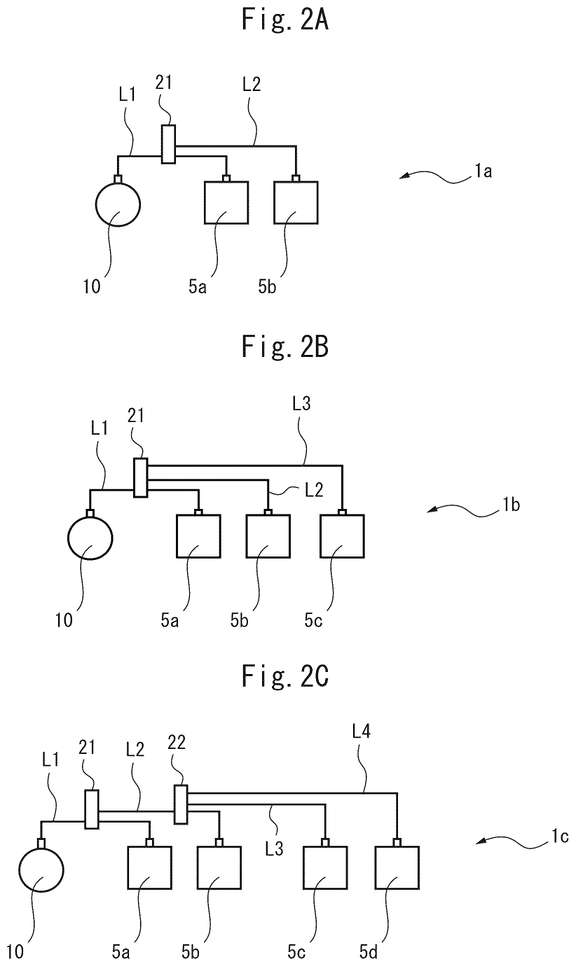

FIG. 2A is a block diagram of a machine based on a first embodiment. The machine 1a shown in FIG. 2A comprises two actuators 5a, 5b. Each of the actuators 5a to 5f includes a motor, a reducer, an amplifier, etc., but these have been omitted from the illustration for the sake of brevity. The same is true for the other actuators 5c to 5f, which are described later.

In FIG. 2A, the first actuator 5a of the machine 1a and the external power source 10 are connected to each other by a first filamentary body L1. The first filamentary body L1 is, for example, a power bus or a power cable. The same is true for the other filamentary bodies L2 to L6, which are described later. A first wiring part 21 is provided between the first actuator 5a and the external power source 10. The first wiring part 21 is a portion for wiring such that the first filamentary body L1 for supplying current can branch to at least one other filamentary body. The first wiring part 21 can be, for example, a terminal block comprising a plurality of terminals. A second filamentary body L2 extends from the first wiring part 21 and is connected to the second actuator 5b.

As can be seen from FIG. 2A, it is sufficient that the first actuator 5a comprise a single connector to be connected to the first filamentary body L1. Likewise, it is sufficient that the second actuator 5b comprise a single connector to be connected to the second filamentary body L2. Specifically, the actuators 5a, 5b need not comprise a plurality of terminals, such as an input terminal and an output terminal, and as a result, the actuators 5a, 5b can be manufactured in a small space. As a result, the machine 1a including the actuators 5a, 5b can achieve space saving.

Further, in the embodiment shown in FIG. 2A, the second filamentary body L2 is connected using the first wiring part 21. Specifically, it is possible to eliminate the need for soldering operations or branching processing using a branch connector in the manner of the bus connector of the prior art, and thus a highly reliable machine 1a can be provided.

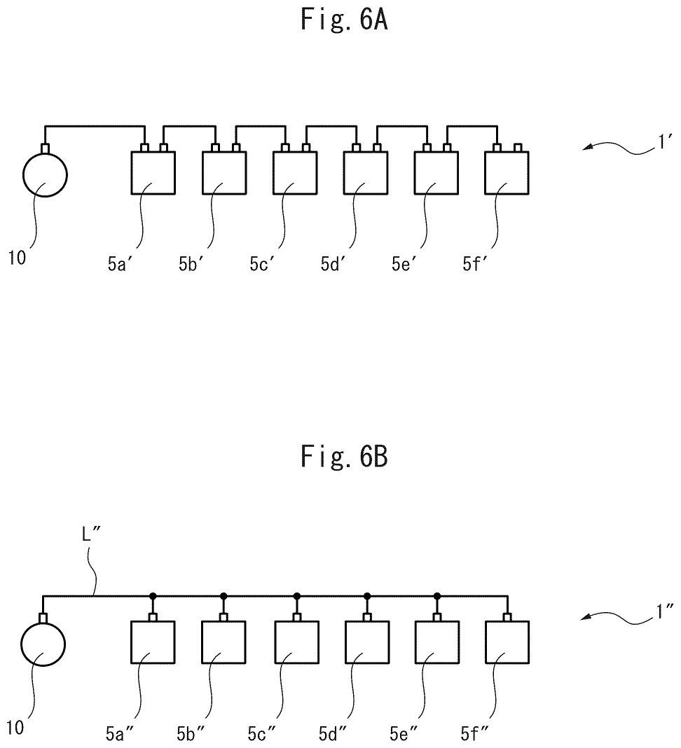

FIG. 6A is a block diagram of a machine according to the prior art. A machine 1′ comprising a plurality of actuators 5a′ to 5f′ is shown in FIG. 6A. Each of the actuators 5a′ to 5f′ is daisy-chain connected. Thus, each of the actuators 5a′ to 5f′ requires an input terminal and an output terminal. As a result, the prior art has a problem in that each of the actuators 5a′ to 5f′ and the machine 1′ become large in size.

Furthermore, FIG. 6B is a block diagram of a machine according to the prior art. A machine 1″ comprising a plurality of actuators 5a″ to 5f″ is shown in FIG. 6B. A filamentary body L″ is connected to the external power source 10. Each of the plurality of actuators 5a″ to 5f″ is bus-connected to the filamentary body L″. Thus, in order to connect each of the plurality of actuators 5a″ to 5f″ to the filamentary body L″, soldering operations or branching processing using a branch connector has been required. Thus, a decrease in the reliability of the machine 1″ could occur.

FIG. 2B is a block diagram of a machine based on a first modification example of the first embodiment. The machine 1b shown in FIG. 2B comprises three actuators 5a to 5c. A second filamentary body L2 and a third filamentary body L3 are connected to the first wiring part 21. The third filamentary body L3 is connected to the third actuator 5c. In this manner, a configuration in which a plurality of filamentary bodies L2, L3 are connected to the first wiring part 21 may be adopted, and the same effects as described above can be obtained.

FIG. 2C is a block diagram of a machine based on a second modification example of the first embodiment. The machine 1c shown in FIG. 2C comprises four actuators 5a to 5d. A second wiring part 22 is provided in the filamentary body L2. The second wiring part 22 has the same configuration as the first wiring part 21, and is a portion for wiring such that the filamentary body L2 can branch to at least one other filamentary body. However, the second wiring part 22 is provided in the filamentary body L2 connected to the first wiring part 21, whereas the first wiring part 21 is provided in the first filamentary body L1 connected to the external power source 10.

The third filamentary body L3 and a fourth filamentary body L4 extend from the second wiring part 22. The third filamentary body L3 is connected to the third actuator 5c, and the fourth filamentary body L4 is connected to the fourth actuator 5d. In this manner, a configuration in which a plurality of filamentary bodies L3, L4 are connected to the second wiring part 22 may be adopted, and in this case as well, the same effects as described above can be obtained.

FIG. 2D is a block diagram of a machine based on a third modification example of the first embodiment. The machine 1d shown in FIG. 2D comprises five actuators 5a to 5e. The second wiring part 22 is provided in the third filamentary body L3. The fourth filamentary body L4 and a fifth filamentary body L5 further extend from the second wiring part 22. The fourth filamentary body L4 is connected to the fourth actuator 5d, and the fifth filamentary body L5 is connected to the fifth actuator 5f. In this manner, a configuration in which a plurality of filamentary bodies L3, L4, and L5 are connected to the second wiring part 22 may be adopted, and the same effects as that described above can be obtained.

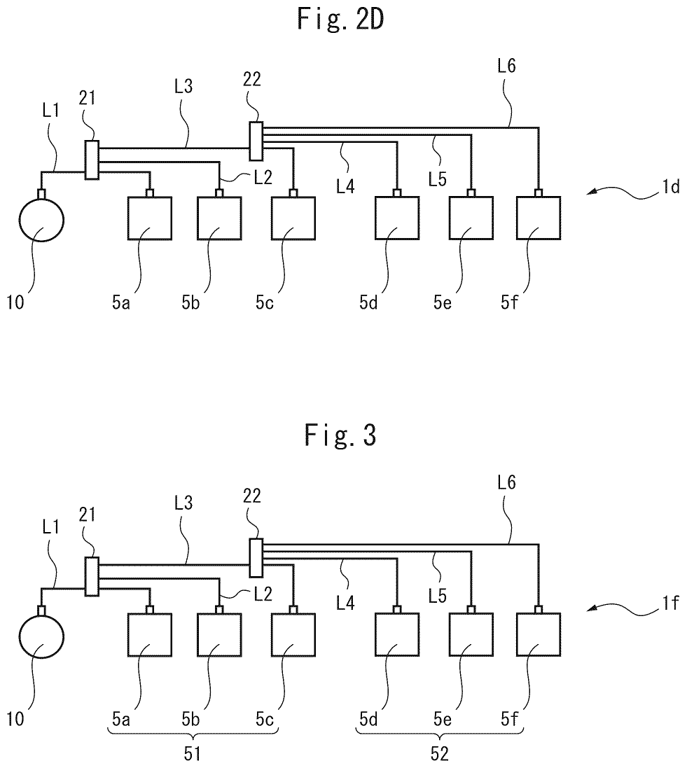

Furthermore, FIG. 3 is a block diagram of another machine based on the second embodiment. The machine 1f shown in FIG. 3 comprises six actuators 5a to 5f. In FIG. 3, a plurality of filamentary bodies L2, L3 are connected to the first wiring part 21 provided in the first filamentary body L1. Furthermore, a plurality of filamentary bodies L4 to L6 are further connected to the second wiring part 22 provided in the third filamentary body L3. The plurality of filamentary bodies L4 to L6 are respectively connected to the fourth actuator 5d through the sixth actuator 5f. In this manner, the case in which a plurality of filamentary bodies L2, L3 are connected to a single first wiring part 21 and a plurality of filamentary bodies L4 to L6 are connected to a single second wiring part 22 is also included in the scope of the present disclosure.

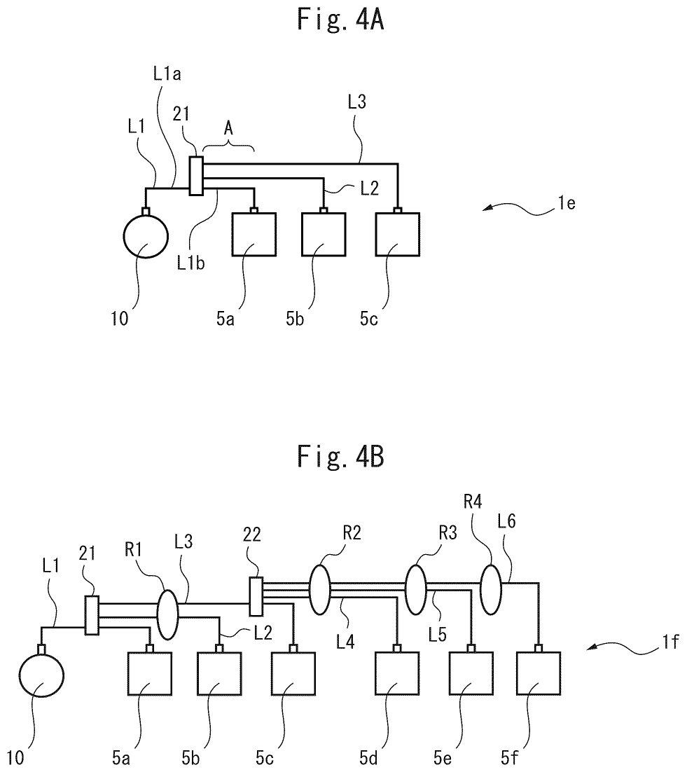

FIG. 4A is a diagram similar to FIG. 2B. The first filamentary body L1 of the machine 1e shown in FIG. 4A is divided into a first filamentary body portion L1a positioned between the external power source 10 and the first wiring part 21, and a first filamentary body portion L1b positioned between the first wiring part 21 and the first actuator 5a. The first filamentary body portion L1a is thicker than the first filamentary body portion L1b.

In FIG. 4A, a region A which is positioned between the first wiring part 21 and the first actuator 5a is shown. The first filamentary body portion L1b and two filamentary bodies L2, L3 are present in region A. The thickness of the two filamentary bodies L2, L3 is approximately equal to the thickness of the first filamentary body portion L1b.

The first filamentary body portion L1a of the first filamentary body L1 is sufficiently thick so as to supply the current required for the three actuators 5a to 5c, whereas the first filamentary body portion L1b and the two filamentary bodies L2, L3 need only be sufficiently thick so as to supply the current required for the corresponding single actuator.

Thus, although the first filamentary body portion L1b and the filamentary bodies L2, L3 are present in the region A, the total thickness of these is sufficient to be approximately the same as that of the first filamentary body portion L1a. Specifically, although the total number of the filamentary body portion L1b and the filamentary bodies L2, L3 in the region A is large, no additional space is required in the region A. The same is true in other embodiments and other modification examples, and it is possible to reduce the thickness of each filamentary body (and filamentary body portion) in a region where a plurality of filamentary bodies (and filamentary body portions) are present, as described above.

FIG. 4B is a view similar to FIG. 3. In FIG. 4B, in the region between the first actuator 5a and the second actuator 5b, the filamentary bodies L2, L3 are secured by a relay connector R1. Likewise, in the region between the third actuator 5c and the fourth actuator 5d, the filamentary bodies L4 to L6 are secured by a relay connector R2. Likewise, in the region between the fourth actuator 5d and the fifth actuator 5e, the filamentary bodies L5, L6 are secured by a relay connector R3.

As can be understood from FIG. 4B, a certain actuator, for example, the actuator 5c, is positioned upstream of the subsequent actuator, for example, the actuator 5d, in terms of the flow of current from the external power source 10. A relay connector, for example, the relay connector R2, secures a plurality of filamentary bodies, for example, the filamentary bodies L4, L5, and L6, between a certain actuator, for example, the actuator 5c, and the subsequent actuator, for example, the actuator 5d.

In this manner, in a region where a plurality of filamentary bodies are present, for example, between the actuator 5c and the actuator 5d, it is preferable that the plurality of filamentary bodies be secured by relay connector. In particular, when the machine 1f is a robot, the relay connectors R1 to R3 group the plurality of filamentary bodies together inside the machine 1f, thereby preventing the plurality of filamentary bodies from being exposed to the outside of the machine 1f and facilitating wiring operations inside the machine 1f.

Furthermore, in the region between the fifth actuator 5e and the sixth actuator 5f, the filamentary body L6 may be secured by the relay connector R4. In this case, another filamentary body, for example, a filamentary body for operating an end effector (not illustrated) positioned on the tip side of the robot relative to the sixth actuator 5f, may be secured by the relay connector R4. In this case, the same effects as described above can be obtained.

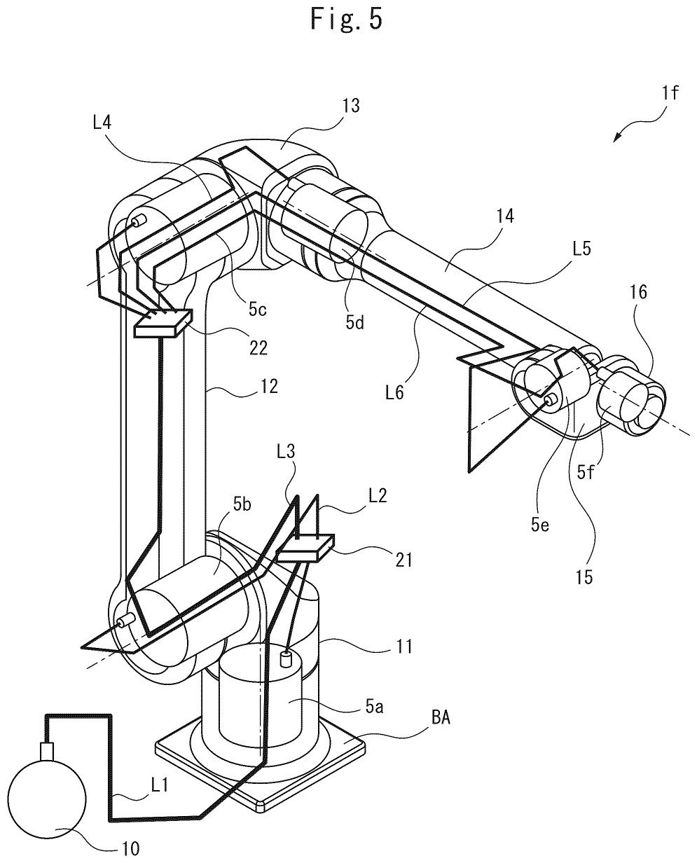

FIG. 5 is a view similar to FIG. 1. The six-axis vertical articulated robot 1f shown in FIG. 5 comprises a first arm member 11 which extends vertically relative to a base member BA and which is rotatable about a first axis, a second arm member 12 which is supported so as to be rotatable about a second axis extending horizontally relative to the first arm member 11, a third arm member 13 which is supported so as to be rotatable about a third axis extending horizontally at the tip side of the second arm member 12, a fourth arm member 14 which is supported by the third arm member 13 so as to be rotatable about a fourth axis extending in the extension direction of the third arm member 13, a fifth arm member 15 which is supported by the fourth arm member 14 so as to be rotatable about a fifth axis extending in a direction perpendicular to the fourth axis, and a sixth arm member 16 which is supported by the fifth arm member 15 so as to be rotatable about a sixth axis.

Each of the first to sixth axes is perpendicular to the adjacent other axes. The first actuator 5a through the sixth actuator 5f are arranged inside the robot 1f in correspondence with the first to sixth axes, respectively.

Referring again to FIG. 3, a first group 51 consisting of three or more actuators, actuators 5a to 5c, is shown. The first filamentary body L1 connects the external power source 10 and the actuator 5a, which is one of the actuators of the first group 51. The first wiring part 21 is arranged in the first filamentary body L1. Furthermore, in FIG. 3, the remaining actuators 5b, 5c of the first group 51, excluding the one actuator 5a described above, are each connected to the first wiring part 21 by the filamentary bodies L2, L3.

Further, in FIG. 3, a second group 52 consisting of at least one actuator 5d to 5f is further shown. The second wiring part 22 is provided in the third filamentary body L3. Furthermore, at least one additional filamentary body L4 to L6 is arranged so as to connect at least one actuator 5d to 5f of the second group 52 and the second wiring part 22.

In FIG. 5, the wiring parts 21, 22 and the filamentary bodies L1 to L6 are arranged in the robot 1f based on the configuration of FIG. 3. As can be understood from FIG. 5, the first wiring part 21 is arranged near the first arm member 11 of the robot 1f, and can also be mounted inside the first arm member 11. Furthermore, the first arm member 11 is positioned on the base end side of the robot 1f. The sixth arm member 16 of the machine 1f substantially never moves near the first arm member 11, and thus there are no problems regarding space for the first wiring part 21.

Furthermore, the second wiring part 22 is arranged inside the second arm member 12, which is rotatably connected to the first arm member 11. Thus, the presence of the second wiring part 22 does not change the external shape of the robot 1f, for example, the external shape of the second arm member 12. As a result, there are no problems regarding space for the second wiring part 22.

In this manner, when the machine 1f includes a plurality of groups 51, 52 and each of the plurality of groups 51, 52 includes a plurality of actuators, it is preferable that each of the groups 51, 52 comprise the wiring parts 21, 22. The reason for this is that by arranging the wiring parts 21, 22 in portions of the machine 1f where there is ample space, it is possible to prevent the machine 1f from becoming large. Thus, it is particularly advantageous to apply the configuration shown in FIG. 3 to the six-axis vertical articulated robot 1f as shown in FIG. 5.

As an advantage of at least one of the embodiments described above, since a single terminal is sufficient for the actuator, the actuator and the machine do not become larger. Specifically, a space-saving machine composed of a plurality of actuators comprising only one terminal can be provided. Furthermore, soldering operations or branching processing using a branch connector becomes unnecessary, which can improve the reliability of the machine.

Although the embodiments of the present disclosure have been described in detail, the present disclosure is not limited to the individual embodiments described above. Various additions, replacements, modifications, or partial deletions can be made to these embodiments within the scope of the spirit of the invention, or within the scope of the idea and intent of the present invention derived from the contents described in the claims and their equivalents. For example, the order of each operation and the order of each process of the embodiments described above are shown as examples, and are not limited to these. The same applies when numerical values or formulas are used in the description of the embodiments described above. Furthermore, appropriate combinations of some of the embodiments described above are included in the scope of the present disclosure.

In relation to the embodiments and modification examples described above, the following addendums are further disclosed.

### (Addendum 1)

A machine comprising:
a first actuator and a second actuator,
a first filamentary body for connecting an external power source and the first actuator,
a first wiring part provided in the first filamentary body, and
a second filamentary body for connecting the second actuator and the first wiring part.

### (Addendum 2)

The machine according to Addendum 1, further comprising:
a third actuator, and
a third filamentary body for connecting the third actuator and the first wiring part.

### (Addendum 3)

The machine according to Addendum 1, further comprising:
at least one additional actuator,
a second wiring part provided in the second filamentary body, and
at least one additional filamentary body for connecting the at least one additional actuator and the second wiring part.

### (Addendum 4)

The machine according to Addendum 2, further comprising:
at least one additional actuator,
a second wiring part provided in the third filamentary body, and
at least one additional filamentary body for connecting the at least one additional actuator and the second wiring part.

### (Addendum 5)

A machine, comprising:
a first group consisting of three or more actuators,
a first filamentary body for connecting an external power source and one actuator of the first group,
a first wiring part provided in the first filamentary body, and
at least one additional filamentary body for connecting at least one remaining actuator of the first group, excluding the one actuator, and the first wiring part.

### (Addendum 6)

The machine according to Addendum 5, further comprising:
a second group consisting of at least one actuator,
a single second wiring part provided in the at least one second filamentary body, and
at least one additional filamentary body for connecting the at least one actuator of the second group and the second wiring part.

### REFERENCE SIGNS LIST

1, 1a to 1f machine
5c to 5f actuator
BA base member
11 first arm member
12 second arm member
13 third arm member
14 fourth arm member
15 fifth arm member
16 sixth arm member
21 first wiring part
22 second wiring part
51 first group
52 second group
L1 to L6 filamentary body
L1a, L1b first filamentary body portion
R1 to R3 relay connector

What is claimed is:

1. A machine, comprising:
a first actuator and a second actuator;
a first filamentary body for connecting an external power source and the first actuator;
a first wiring part provided in the first filamentary body; and
a second filamentary body for connecting the second actuator and the first wiring part.

2. The machine according to claim 1, further comprising:
a third actuator; and
a third filamentary body for connecting the third actuator and the first wiring part.

3. The machine according to claim 1, further comprising:
at least one additional actuator;
a second wiring part provided in the second filamentary body; and
at least one additional filamentary body for connecting the at least one additional actuator and the second wiring part.

4. The machine according to claim 2, further comprising:
at least one additional actuator;
a second wiring part provided in the third filamentary body; and
at least one additional filamentary body for connecting the at least one additional actuator and the second wiring part.

5. A machine, comprising:
a first group consisting of three or more actuators;
a first filamentary body for connecting an external power source and one actuator of the first group;
a first wiring part provided in the first filamentary body; and
at least one additional filamentary body for connecting at least one remaining actuator of the first group, excluding the one actuator, and the first wiring part.

6. The machine according to claim 5, further comprising:
a second group consisting of at least one actuator;
a single second wiring part provided in the at least one second filamentary body; and
at least one additional filamentary body for connecting the at least one actuator of the second group and the second wiring part.
